(19) United States
(12) Patent Application Publication
(10) Pub. No.: US 2011/0151172 A1
(43) Pub. Date: Jun. 23, 2011

(54) PRESTRESS STRUCTURAL MATERIAL FORMED BY REORGANIZATION WITH POLYGONAL ORIGINAL BAMBOO AND THE MANUFACTURING METHOD

(76) Inventors: Wansi Fu, Beijing (CN); Ying Yu, Beijing (CN); Jianbo Zhou, Beijing (CN)

(21) Appl. No.: 13/059,697

(22) PCT Filed: Jun. 1, 2009
(86) PCT No.: PCT/CN09/72067

§ 371 Date: Feb. 18, 2011

(30) Foreign Application Priority Data
Aug. 22, 2008 (CN) 200820109893.3
May 14, 2009 (CN) 200910084441.3
May 27, 2009 (CN) 200910203495.7

(51) Int. Cl. B32B 3/12; B32B 3/00; B27J 7/00

(52) U.S. Cl. 428/58; 144/333

(57) ABSTRACT

The invention provides a prestress structural material formed by reorganization with polygonal bamboo units and the manufacturing method for it, the manufacturing method includes manufacturing substrate of prestress structural material formed by reorganization with polygonal bamboo units, and the adding of reinforcement material. Bamboo unit undergoes boiling with chemical solution, drying, and then milling the unit on its outer surface, in order to make it become polygonal bamboo segment, arranging abreast side by side in cross-section direction and longitudinally elongating by finger joints, after all, the substrate of prestress structural material formed by polygonal original bamboo units is formed; after those, extending the lacing wire through all or part of bamboo unit of substrate, and the high-strength baffles are disposed on both ends of substrate, fastening both ends of tautened substrate on baffles by anchors or nuts, allowing the lacing wire act as reinforcement material, then the prestress structural material is formed. The invention makes full use of the structure and physical characteristic of original bamboo, and the prestressed effect generated by lacing wire, the environmental friendly structural material with high-intensity, large span, low power, which effectively alleviates the contradiction between China's timber supply and demand, and partially substitutes for concrete and steel materials, it has broad development prospect.

### TECHNICAL FIELD

The present invention belongs to structural material field, relates to prestress structural material formed by reorganization with polygonal original bamboo and the method for manufacturing.

### BACKGROUND

In China, bamboo species, bamboo forest area and growing stock volume ranks are the highest in the world, which is the country richest bamboo resources in the world. Bamboo has a rapid growth, short-rotation characteristics, and high strength, toughness, hardness, high density outside and sparse density inside, it also has a good bionics researching advantage, the main mechanical properties of bamboo can be comparable with hard hardwood materials. Reorganizing the hollow bamboo into composite materials can replace the wood, make full use of bamboo structures, its original state of the physical characteristics and pre-stretch tension of the lacing wire, which could be processed into high-intensity, large span, low power consumption, environmental protection and structural material. It can be able to alleviate China's timber supply demand effectively, and can partly replace concrete and steel materials. It has broad development prospect.

The existing bamboo reorganizing and relative construction materials technology:

(1) The bamboo square reorganizing technology: hollow bamboo is splited into arc blank, then processed into a certain size bamboo square bar, which are glued to form a bamboo board or bamboo square material. Shortcomings and deficiencies of the technology are: cutting the arc blank in to foursquare bar results in substantial waste of raw materials, which leads generally less than 30% utilization rate.

(2) The crushing bamboo reorganizing technology: After crushing the whole bamboo, It could be reorganized and glued together to form bamboo board or bamboo square material. Shortcomings and deficiencies of the technology are: 1) Natural bamboo texture is damaged in varying degrees; 2) Bamboo board or bamboo square material would form small within gap to affect quality cross-section.

(3) Small diameter bamboo reorganizing technology:

Small diameter bamboo will be kneaded into the bundle, re-glued together to form a bamboo board or bamboo square material. Shortcomings and deficiencies of the technology are: The macro-structure of natural bamboo is damaged, and lost the “original state”, shows the poor surface quality, which can not replace high-grade solid wood.

(4) Original arc bamboo reorganizing technology:

With the arc bamboo that its inner and outer radius is equal, and the smooth bamboo green and tabasheer, the original arc bamboo are placed abreast and boned with pressure in the same direction. Shortcomings and deficiencies of the technology are: The material is formed by the superposition of arc bamboo, it does not utilize with natural structure of bamboo, like the hollow structure and knots, so that manufacturing of large-scale structure is diseconomy.

(5) Carbon fiber reinforced plastic/bamboo composite technology:

It's composited to be high-strength composite material by high-performance carbon fiber reinforced plastic and bamboo structure, via certain processing procedures. Shortcomings and deficiencies of the technology are: 1) It can not be used alone as high-intensity, long-span structures and other building materials; 2) high manufacturing requirement and high cost; 2) during composite processing, hollow bamboo and other unique physical structure are broken, it can't keep bamboo state in the real sense.

(6) Tensile sinew prestressed concrete technology:

In order to avoid premature cracking of lacing wire concrete structure, before structural material undergoing the working load, high-strength lacing wire and concrete are used to exert pressure to the concrete in the pulling area, in order to generate prestress to decrease or cancel the tensile stress caused by loading, so that tensile stress of structure component can be control in narrow range, then cracking and crack expansion of concrete can be postponed, and the cracking-resistance and the stiffness can be improved. Main disadvantages of this technique: 1) high manufacturing requirement, and long construction period; 2) High energy consumption, and it goes against environmental protection, and unrecycles, is not an environmental friendly building material.

Several such techniques described above can not fully reflect the characteristics of original state bamboo, such as structure, physical properties, etc., not only the mechanical performance per unit mass is not high, but also the requirement of high strength, long range, large span restructuring can not be achieved. However, requirement and cost of manufacturing technology of reinforced concrete building materials are higher, and it's not environmental-friendly material, so the materials described above can not be used as environmental friendly structural materials.

### SUMMARY OF THE INVENTION

An object of the present invention is to provide the prestress structural material formed by reorganization with polygonal original bamboo, which can improve the deficiencies of existing technologies. It can be combined with the reinforcement material, so it can be processed into high strength, large span, the original state of bamboo utilization of structural materials.

Another object of the present invention is to provide the manufacturing methods for the structural material described above.

An object of the present invention is to provide the prestress structural material formed by reorganization with polygonal original bamboo, which includes plurality bamboo unit with polygonal cross-section, adhesive is coated on adjacent connecting outer surfaces of each two bamboo units, in order to bonding those plurality bamboo units together with this adhesive layer, which forms the laterally side by side arranging structure, then the freely lateral expansion can be achieved; finger jointing structure are disposed at both ends of said two bamboo units for longitudinally connecting, adhesive is coated on the connecting faces of finger joints of bamboo units, plurality bamboo units bond together with this adhesive, then the freely longitudinally elongation can be achieved, then the prestress structural material formed by reorganization with polygonal original bamboo is formed; stress steel elements extend through part of bamboo unit of prestressed structural material formed by polygonal original bamboo unit, baffles are disposed at both ends of structural material for fastening the stress steel elements, both ends of said stress steel elements can be fastened on baffles.

Said anchors can be selected from building universal anchorage or bamboo appropriative anchorage, depending on the needs, said steel elements could be steel, steel beams and steel strand bundles and other prestressed materials.

Holes corresponding to the protrusion of stress steel elements are disposed on said baffle at the protrusion spots; both ends of the stress steel parts stick out from said hole, and are fastened on the baffle.

Said stress steel elements are tautened by anchors in order to fastening the stress steel elements on baffles in form of generating prestress; and/or the ends of stress steel elements that protrudes from outer side of baffle are amputated, in order to ensure the ends of stress steel elements are flush with outer surface of anchors or baffles.

Both ends of said stress steel element are disposed with buckles, in order to rotatablely engage with nuts, which enables both ends of said stress steel element being tautened in the form of generating the prestress on said baffle; and/or either end of stress steel elements is flush with the outer surface of anchors or baffles.

Said stress steel elements may be steel, steel beams and steel strand bundles and other prestressed materials.

Said bamboo unit formed by bamboo segments with certain length, average diameter difference clearance of segments in same group could be within ±15 mm; according to the size of segment cross-section, the segments can be divided into different group, segments in the same group has the basically same cross-section, which ensures that side width at both ends of manufactured polygonal bamboo unit are equal, and avoid that longitudinal gaps shows at smaller diameter part of prestress structural material formed by reorganization with polygonal original bamboo.

Processing outer surface of bamboo units into plurality longitudinal planes, that means both ends of bamboo segment are processed according to standard polygon to be standard polygon, or standard polygon at one end and non-standard polygon at the other end, or non-standard polygon at both ends, said non-standard polygon is formed by original bamboo arc and straight line, the segments are called “polygonal” bamboo unit. Outer surface of the bamboo segments milled into a regular polygon is intended to obtain bonding faces that used in laterally expansion of bamboo unit, since the arcs kept partly, so it is not the real polygon.

Ratio between the length of straight line L2 of cross-section of polygonal bamboo unit and side length of inscribed polygon in the circle that has same diameter is called multi-degree (seen FIG. 7). In order to ensure enough bonding area, and the favorable bonding among units, during the milling of polygons, the multi-degree can not be lower than 40%, preferably range is 60%-80%. The cutting part of bamboo increases as the value of multi-degree increases, so the strength of bamboo decrease, as well as the utilization rate; if the value of multi-degree being too small, so the side face of polygon bamboo unit can't have sufficient bonding area, that can result in poor bonding strength.

Edge number of said polygon unit, namely the number of sides, can be 4-8, and preferably 6. Regular hexagonal bamboo units are jointing laterally and tightly, outer side of the bamboo units fit tightly without leaving any gaps, and outer side of bamboo unit processed into regular hexagonal can lead to less cutting removal of bamboo wall. If the edge number being too little, then it has to cut a lot of bamboo wall to be polygon, undoubtedly wasting too much bamboo along with weakening the bamboo strength. If the edge number being too much, the area of outer side processed is smaller, so the lateral bonding strength of each bamboo unit decreases.

Finger joints are milled at both longitudinal connecting ends of bamboo unit, then the adhesive is coated on the bonding face of finger joints; selecting polygonal bamboo unit that has equivalent diameter and unified outer surface to press and/or cure under heating condition, so the finger jointing assembly with unlimited length can be achieved, and single blank can be obtained. Said prestress structural material formed by reorganization with polygonal original bamboo can be elongated to any required length via said finger jointing pattern.

Meanwhile, said structural material can be laterally expanded while it is longitudinally elongated. After or before the elongating of said bamboo unit, prestress structural material formed by reorganization with polygonal original bamboo can be formed by bonding on the side faces of the units in form of juxtaposing according to honeycomb. Said prestress structural material formed by reorganization with polygonal original bamboo includes bamboo units that has the same or different cross-section size, edge number. For example, it can be selected from following cases:

Said plurality bamboo units has the same cross-section size and edge number; or

Said prestress structural material formed by reorganization with polygonal original bamboo includes two or more bamboo units, bamboo in the same unit has the same cross-section size and edge number, while bamboo in different unit has different cross-section size and/or edge number, bamboo in the same unit or different units laterally bond on the outer side into lateral expansion structure; or

Said prestess structural material formed by reorganization with polygonal original bamboo includes bamboo units that has the same cross-section size and edge number, as well as one wooden unit that has plurality cross-section different from the cross-section of bamboo unit, and the cross-section of wooden unit fits the gaps formed by reorganized with bamboo unit and fills into said gaps.

For instance, said prestress structural material formed by reorganization with polygonal original bamboo includes one unit formed by plurality octagonal bamboo and one unit formed by plurality foursquare bamboo, side length of cross-section of said foursquare bamboo unit correspondingly equals to side length of cross-section of said octagonal bamboo unit, or multiples, in order to place the foursquare bamboo unit into the gaps formed after bonding the said octagonal bamboo unit together;

As another example, said prestress structural material formed by reorganization with polygonal original bamboo includes two foursquare bamboo units, each has different side length from the other.

Arranging bamboo units laterally according to requirements can increase the cross-section area, so the lateral expansion with any width can be achieved. Seam of longitudinally finger jointing of said bamboo unit arrange in the form of alternatively as far as possible, in order to avoid mechanical strength reducing at interface. Said adhesive can be selected from conventional adhesives, such as UF (urea-formaldehyde resin), PF (phenolic resin), MDI (isocyanate glue) or other adhesive used in the field. Pattern and condition of bonding are also conventional.

Said prestress structural material formed by reorganization with polygonal original bamboo can be processed further, that is processing on length, edges and surfaces, via such as sawing, trimming etc., and surface treating like planning, sanding and coating, etc., in order to produce prestress structural material formed by reorganization with polygonal original bamboo that has set size and surface quality.

Said prestress structural material formed by reorganization with polygonal original bamboo includes the prestress structural material formed by reorganization with polygonal original bamboo, through which stress steel element going and baffles locating at both ends of the structural material. Part of knots of prestress structural material are cut through for the stress steel elements going through; the stress steel elements can be disposed in the form of going through the bamboo unit located at underlying and/or corners and/or periphery and/or center of the cross-section of the structural material. The underlying of structural material are the most fragile part during pressure-bearing, so the ideal way to solve this situation is to dispose the stress steel elements in the form of going through the underlying unit of structural material. Baffles are disposed at both ends of prestress structural material formed by reorganization with polygonal original bamboo for fastening the stress steel elements, holes are disposed on baffles where the stress steel element protrude from; both ends of stress steel elements extend through the holes, then are fastened on the baffle. Means for fastening said stress steel elements can be buckles at both ends of stress steel elements, then threads the nuts to fasten the elements, or using common anchor of architecture; by fastening the nuts or anchors, stress steel elements can be tautened, then the prestress generates, which improves the mechanical strength of prestress structural material formed by reorganization with polygonal original bamboo; ends of elements that protrudes from the baffle can be cut when it's being used, in order to provide convenience.

To achieve the goal, the present invention adopt the following technology plans:

The present invention provides the manufacturing method of prestress structural material formed by reorganization with polygonal original bamboo, it includes manufacturing of substrate of prestress structural material formed by reorganization with polygonal original bamboo, and adding of reinforcement material, said manufacturing of substrate is to connect the original state bamboo unit to be structural material that has set length and cross-section area by lateral and longitudinal connecting; said adding reinforcement material is to use the lacing wire that longitudinally extend through at least part of bamboo unit of said substrate, the lacing wire has the same length with said substrate, then fastening both ends of lacing wire at both ends of substrate, respectively.

Said substrate of prestress structural material formed by reorganization with polygonal original bamboo is formed by plurality bamboo units that has polygonal cross-section, the manufacturing method is: manufacturing plurality flat planes on original bamboo outer surface in order to form bamboo units with polygonal cross-section, adhesive layer coated on outer surfaces of two adjacent laterally contacting bamboo units enables the number of bamboo units bond together, forming laterally side-to-side ranging structure, so that the freely lateral expansion is achieved; finger joints are disposed on longitudinally connecting ends of said two bamboo units, adhesive layer coated on the finger joint connecting face of bamboo units enable the bamboo units firmly connecting together by finger jointing, so that freely longitudinal elongation is achieved, then the prestress structural material formed by reorganization with polygonal original bamboo is formed, after that, disposing the lacing wire extended through at least part of bamboo unit of substrate, the lacing wire is used as the reinforcement material. High strength baffles for fastening the lacing wire are disposed at both ends of said substrate, both ends of said lacing wire are tautened and fastened on baffle.

Manufacturing steps of substrate includes:

A. Confirming the length of bamboo segments: that is cutting bamboo with set length from original bamboo;

B. Boiling: steaming or boiling bamboo segmenst; which is intend to: 1) softening bamboo by boiling it, in order to reduce the internal stress of bamboo, prevent it from cracking and improve durability; 2) part of the starch, sugar, protein and other substances within bamboo can be dissolved from bamboo, so bamboo mildew, vermin and other defects can be reduced; 3) removing excess salt in bamboo cell, cytoplasm, etc., and adding filling material among the cell gap and parenchyma and other part of bamboo to enrich bamboo, in order to improve crack resistance and stability, facilities to long-term use of structural materials.

C. Drying: drying the boiled bamboo segments, to reduce its moisture content; drying of bamboo segment is intended to reduce the internal stress of bamboo segments, prevent the deformation, cracking and other defects occurring during further manufacturing and using. Final moisture content of bamboo can be 5%˜20% after drying.

D. Milling: milling the bamboo segment on its side in order to form polygonal bamboo unit, and finger joint of bamboo segment for longitudinal connecting is milled at the ends of bamboo segment;

E. Assembling: adhesive is coated on milled side face of bamboo unit and finger mortise connecting surface at the ends of bamboo units, assembling said bamboo units in lateral and longitudinal direction, then by pressing plurality bamboo units under atmosphere of elevated temperature to form said substrate; or the manufacturing steps also includes:

Adding bamboo green removing step between said confirming and boiling step, which is removing the green from outer surface of bamboo segment. For example, using a dedicated machine or manual way to remove the green.

In B boiling step, preferably placing bamboo segment into alum solution or other polymeric compound solution to steam or boil; or placing the segment into vessel that the inside temperature and pressure are high (temperature of 100° C.˜200 ° C., pressure of 0.1 MPa˜1.6 MPa), to boil the segments with alum solution or other polymeric compound solution. The alum solution is heated till the saturated alum solution in boiling water is generated. The specific boiling method is that: throwing alum into water, then heating the solution, then the saturated alum solution is finished. Bamboo segments placed into boiling solution being boiled for about 4-6 hours, then dry it after boiling.

In C drying step, bamboo segments can be placed into precision steam drying kiln of wood to dry. Normally the hypothermia drying is better, that means the drying temperature is 30° C.˜50° C.

Said finger mortise milling and polygon milling can be reversed. The order of the lateral and longitudinal assembling steps can be reversed.

Substrate is made by segments from original bamboo, the average diameter difference clearance of bamboo is within ±15 mm, and diameter difference of two ends of bamboo segment is within ±10 mm; dividing segment into groups according to the size of cross-section of segments, the segments in the same group have the same cross-section substantially, in order to ensure the width of processed polygonal bamboo unit at its both ends are equal, and avoid the longitudinal gap appears at smaller part of assembled prestress structural material.

Processing outer surface of bamboo units into plurality longitudinal planes, that means segment that both ends of bamboo segments are processed according to standard polygon to be standard polygon, or standard polygon at one end and non-standard polygon at the other end, or non-standard polygon at both ends, said non-standard polygon is formed by original bamboo arc and straight line, so the segments are called “polygonal” bamboo unit. Outer surface of the bamboo segments milled into a regular polygon is intended to obtain bonding faces used in laterally expansion of bamboo unit, since the arcs kept partly, so it is not the real polygon.

Ratio between the length of straight line L2 of cross-section of polygonal bamboo unit and side length of inscribed polygon in the circle that has same diameter is called multi-degree(seen FIG. 7). In order to ensure enough bonding area, and the favorable bonding among units, during the milling of polygons, the multi-degree can not be lower than 40%, preferably range is 60%˜80%. the removing part of bamboo increases as the value of multi-degree increases, so the strength of bamboo decrease, as well as the utilization rate; if the value of multi-degree being too small, so the side face of polygon bamboo unit can't have sufficient bonding area, that can result in poor bonding strength.

Edge number of said polygon unit, namely the number of sides can be 4-8, and preferably 6. Regular hexagonal bamboo units are jointing laterally and tightly, outer side of the bamboo units fit tightly without leaving any gaps, and outer side of bamboo unit being processed into regular hexagonal can lead to less cutting removal of bamboo wall. If the edge number being too little, then it has to cut a lot of bamboo wall to be polygon, undoubtedly wasting too much bamboo along with weakening the bamboo strength. If the edge number being too much, the area of outer side processed is smaller, so the lateral bonding strength of each bamboo unit decreases.

Finger joints are milled at both longitudinal connecting ends of bamboo unit, then the adhesive is coated on the bonding face of finger joints; selecting polygonal bamboo unit that has equivalent diameter and unified outer surface to press and/or cure under heating condition, so the finger jointing assembly with unlimited length can be achieved, and single long material can be obtained. Said substrate of prestress structural material formed by reorganization with polygonal bamboo unit can be elongated to any required length via said finger jointing pattern.

Said structural material can be laterally expanded while it is being longitudinally elongated. After or before the elongating of said bamboo unit, prestress structural material formed by reorganization with polygonal bamboo unit can be formed by bonding on the side faces of the unit in form of juxtaposing according to honeycomb. Said substrate prestress structural material formed by reorganization with polygonal bamboo unit includes bamboo units that has the same or different cross-section size, edge number. For example, it can be selected from following cases:

Said plurality bamboo unit has the same cross-section size and edge number; or

Said substrate of prestress structural material formed by reorganization with polygonal bamboo unit includes two or more bamboo units, bamboo in the same unit has the same cross-section size and edge number, while bamboo in different unit has different cross-section size and/or edge number, bamboo in the same or different unit laterally bond on the outer side into lateral expansion structure; or

Said substrate of prestress structural material formed by reorganization with polygonal bamboo unit includes bamboo units that has the same cross-section size and edge number, as well as one wooden unit that has plurality cross-sections different from the cross-section of bamboo unit, and the cross-section of wooden unit fits the gaps formed by reorganized with bamboo unit and fills into said gaps.

For instance, said substrate of prestress structural material formed by reorganization with polygonal bamboo unit includes one unit formed by plurality octagonal bamboo and one unit formed by plurality foursquare bamboo, side length of cross-section of said foursquare bamboo unit correspondingly equals to side length of cross-section of said octagonal bamboo unit, or multiples, in order to place the foursquare bamboo unit into the gaps formed after bonding the said octagonal bamboo unit together;

As another example, said substrate of prestress structural material formed by reorganization with polygonal bamboo unit includes two foursquare bamboo unit, each has different side length from the other.

Arranging bamboo units according to requirements can increase the cross-section area, so the lateral expansion with any width can be achieved. Seam of longitudinally finger jointing of said bamboo unit arrange alternatively as far as possible, in order to avoid reducing of mechanical strength at interface. Said adhesive can be selected from conventional adhesives, such as UF (urea-formaldehyde resin), PF (phenolic resin), MDI (isocyanate glue) or other adhesive used in the field. Pattern and condition of bonding are also conventional.

Said prestress structural material formed by reorganization with polygonal bamboo unit includes substrate of prestress structural material formed by reorganization with polygonal bamboo unit, the lacing wire extending through the substrate as reinforcement material and high-strength baffles disposed at both ends of substrate. The tautened layer of structural material are the most fragile part during pressure-bearing, so the ideal way to solve this situation is to dispose the stress steel elements at tautened layer of substrate. The high strength baffles for fastening said lacing wire are disposed at both ends of substrate, and holes are disposed on baffles correspondingly at where the lacing wire protrudes; lacing wire extends through said holes, then are fastened on baffles. Means for fastening said lacing wire can be buckles and matching nuts at both ends of lacing wire, or common anchor used in architecture; by fastening the nuts or anchor, stress steel elements can be tautened, then the prestress generates, which improves the mechanical strength of prestress structural material formed by reorganization with polygonal bamboo unit; ends of elements that protrudes from the baffle can be cut when it's being used, in order to provide convenience.

Said lacing wire can be material that enable to generate high-strength prestress, such as steel, nylon, rubber, plastics and other high-strength composite materials.

It has to break the knot through to allow the lacing wire extend through, in the principle that the size of breaking holes of knot can keep the knot as much as possible. That means, the breaking hole can be as small as possible, and the size of it has to be allowing the lacing wire extend through.

The innovations of the present invention is that it can make up the disadvantage of bamboo reorganization that original hollow structure of bamboo is always destroyed, and keep the natural and unique structure of bamboo, such as hollow, knots and other characteristics, which can be fully used; advantages of high bonding resistance, compression strength and shearing resistance, and the physical performance can be kept farthest, and the original bamboo characteristics can be reserved, so the utilization rate is improve. Natural bamboo has the circle shape, since the knots and the orderly arranging fiber, the bamboo can show better wind-resistance performance (which means better bonding resistance, and shearing resistance) in lateral direction, and better tensing resistance and compression strength in longitudinal direction. The present invention makes full use of these physical characteristic of bamboo, by making polygonal bamboo unit with finger joints, the reorganization including laterally freely expansion and longitudinally elongation can be realized, which employs the natural mechanical performance of bamboo; and the lacing wire going through the substrate of substrate of prestress structural material formed by reorganization with polygonal bamboo unit, the prestress reinforcement can be added during the fastening of lacing wire, thus the strength can be improved, and the structural material can be used as large scale, and high strength structural material. In prior art, there are so many examples of improving tensing resistance by disposing some reinforcement into beams, for example, steel concrete reinforcement structural material, however, reinforcement located in those beams is disposed by placing the reinforcement into the dies first, then pouring concrete into the dies. But bamboo according to the invention, it is a formed material, so there's no precedent of setting the lacing wire first. Thus, the advantages of the invention are:

Present invention aims at making use of the hollow and knots of bamboo, reorganizing the circle hollow bamboo in form of arranging the polygonal bamboo side by side (for example, the hexagon bamboo can be reorganized into honeycomb), and freely longitudinal elongation, to form the polygonal reorganized material which keeps the original structure of bamboo; extending lacing wire inside partly bamboo unit, and adding prestress when fastening the lacing wire, so the mechanical strength of bamboo can be improved by a large margin, and the prestress structural material formed by reorganization with polygonal bamboo unit can be high-strength and great span. Prestress structural material formed by reorganization with polygonal bamboo unit can not only replace the wood as structural material, improve utilization rate of bamboo, save wood and bamboo resource, but also replace concrete, steel and other structural material, improve the ability of closing to natural.

The invention provides a manufacturing method of prestress structural material formed by reorganization with polygonal bamboo unit. It includes manufacturing of substrate of prestress structural material formed by reorganization with polygonal bamboo unit and adding of reinforcement material. Substrate of prestress structural material formed by reorganization with polygonal bamboo unit can be formed by removing the bamboo green (or not removing), boiling with medicine, drying, milling the outer face of bamboo segment to be the polygonal segment, arranging the segment side by side and longitudinally elongating the segments by finger mortise bonding, then extending the lacing wire through all or partly bamboo unit of substrate of prestress structural material formed by reorganization with polygonal bamboo unit, and disposing high-strength baffles at both ends of substrate, pulling and fastening the lacing wire on the baffle by nuts or anchors, in order to use the lacing wire as reinforcement material, then the prestress structural material is made. Side number of polygonal bamboo unit can be 4-8. The present invention aims at adopting the physical characteristic of bamboo, like hollow, taper, knot, low density at the outside and high density at the inside of bamboo, etc., making full use of original structure of bamboo, physical characteristics of bamboo and the prestress exerted by lacing wire, the structural material with the high-intensity, large span, low consumption energy, environmental protection, a close sense can be made. So it can effectively alleviate the contradiction between China's timber supply and demand, and can partly replace concrete and steel materials, it also has broad development prospect.

The following specific embodiments with drawings and further description of the invention will become clear, it's not the limitation to the present invention, any content in accordance with the invention of any replacement of the same field, falls into the scope of protection of the invention.

### BRIEF DESCRIPTION OF THE DRAWINGS

FIG. 1 shows the bamboo segment that is cut by bamboo selected according to the diameter;

FIG. 2a and 2b are the schematics of two types of hexagonal bamboo unit, respectively;

FIG. 3a and 3b are the structural schematics of the bamboo unit that the ends of it are milling to finger joint, respectively;

FIG. 4 is schematic of the assembling way of bamboo units in the cross-section direction;

FIG. 5 is schematic of the substrate that forms by coating the side face of hexagonal bamboo unit and connecting face of finger joint of hexagonal bamboo units with adhesive, then pressing the assembled units under atmosphere or elevated temperate;

FIG. 6 is the structural schematic of substrate of prestress structural material formed by reorganization with polygonal bamboo unit;

FIG. 7 shows schematically what is degree of polygons;

FIG. 8 is the schematic of substrate of prestress structural material formed by reorganization with matching octagonal and foursquare original bamboo units;

FIG. 9 is the schematic of the position where lacing wire disposed inside all or part of hexagonal bamboo units of substrate of prestress structural material formed by reorganization with hexagonal bamboo unit;

FIG. 10a and 10b shows the lacing wire and high-strength baffle, respectively;

FIG. 11 is the cutaway view of fastening the lacing wire and high-strength baffle in side the bamboo unit;

FIG. 12a, 12b and 12c are the schematic main cutaway view, side elevation view and planform view of substrate of prestress structural material formed by reorganization with polygoanl bamboo unit;

FIG. 13 is the perspective view of substrate of prestress structural material formed by reorganization with hexagonal bamboo units;

FIG. 14 is the main processing flow chart of substrate of prestress structural material formed by reorganization with hexagonal bamboo units.

### EMBODIMENTS

### Example 1

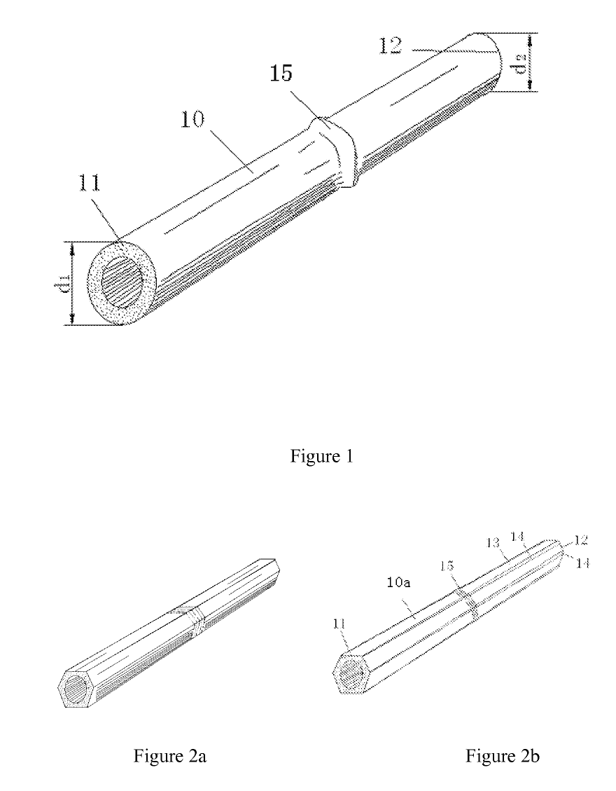

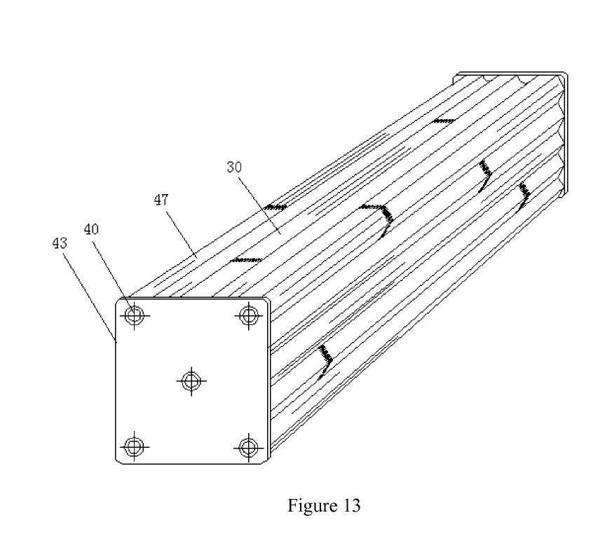

FIG. 12 and FIG. 13 show the prestress structural material formed by reorganization with polygonal bamboo units according to an embodiment of the invention, which the prestress structural material formed by polygonal original bamboo includes plurality hexagonal bamboo units 10a (see FIG. 2a and 2b), adhesive is coated on all or part of the side surface 13 of hexagonal bamboo unit 10a, side surface 13 of plurality bamboo units are bonded together via the adhesive layer, then freely lateral expansion can be achieved; the finger joints disposed at one end or both ends of polygonal bamboo unit 10a enables the bamboo unit jointing with other bamboo unit, so freely longitudinal elongation can be achieved, then the substrate of prestress structural material formed by reorganization with polygonal bamboo unit 49 is formed. Said prestress structural material formed by reorganization with polygonal bamboo unit also includes lacing wire 41 extending through the prestress structural material and the baffles 43, 48 disposed at both ends of the prestressed structural material. Knots of bamboo units that the lacing wire is going to extend through is opened up, then the lacing wire extends through the knots; baffles for fastening the lacing wire are disposed at both ends of prestress structural material, both ends of lacing wire are fastened on the baffles.

Specific steps are described as below:

(1) Firstly, sawing the original bamboo into bamboo segments 10 (see FIG. 1) with certain length, that is confirming the segment, selecting straight bamboo with basically same diameter, taper and wall thickness, confirming the segment by value the difference of diameter at two ends of bamboo d1, d2, if the difference value is between ±15 mm, it can be one segment, segment 10 can be saw with random length (see FIG. 1). There are two rules one have to obey, rule no. 1, sawing position should not be where the knot 15 locates; rule no. 2, difference value of two ends of said segment 10 have to be between ±10 mm. the bamboo green can be removed by mechanic or manual way after the segment confirming according to the particular using requirement, if there's no particular requirement, the green can stay.

(2) Dipping the segment into chemicals solution to soak or boil it, in order to achieve the bamboo cell corrosion, cracking, flame retardant, easy preservation. In examples, segment is placed into alum solution or other polymer solution for boiling; or the segment can be placed into vessel with high inside temperature and pressure, and then boiling the segments with alum solution or other polymer solution. So that alum or other polymer can have the access to go into the gaps of bamboo, and fill the gaps in order to improve the density of bamboo. Specific approach can be: adding alum into the water, heating the solution, and finally the boiling water saturated alum solution is made. Segments placed into boiled solution is boiled for about 5 hours, then dried after boiled. The ideal temperate and pressure for boiling is temperature of 100 ° C.˜200 ° C., pressure of 0.1 MPa˜1.6 MPa.

(3) Air drying or manual drying the boiled bamboo, in order to control the final moisture content between 5-20%. In examples, the segments are placed into precision wood steam drying kiln to dry. Normally, drying under hypothermia temperature is proffered, that is drying the bamboo under 30-50° C.

(4) Milling the dried bamboo segments on the outer surface to make it into hexagonal bamboo (see FIG. 2a), in order to orderly assembling the bamboo units in form of honeycomb in the cross-section direction, when the outer surface of bamboo unit 10a is milled into hexagon, the original partly arc 14 is kept more or less, so the hexagon is not the real hexagon; in practical, the bigger end of bamboo unit 10a can be milled into hexagon, and the smaller end of bamboo unit 10a can be milled into nonstandard hexagon (see FIG. 2b), or both ends of bamboo unit 10a can be milled into nonstandard hexagon.

In order to ensure the side surface 13 is big enough for bonding, during milling, ratio between side length of cross-section profile of hexagonal bamboo unit L2 and side length of inscribed hexagonal in the circle that has same diameter is called hexagonal-degree, hexagonal-degree of the embodiment is 70%, that is L2/L1=70%.

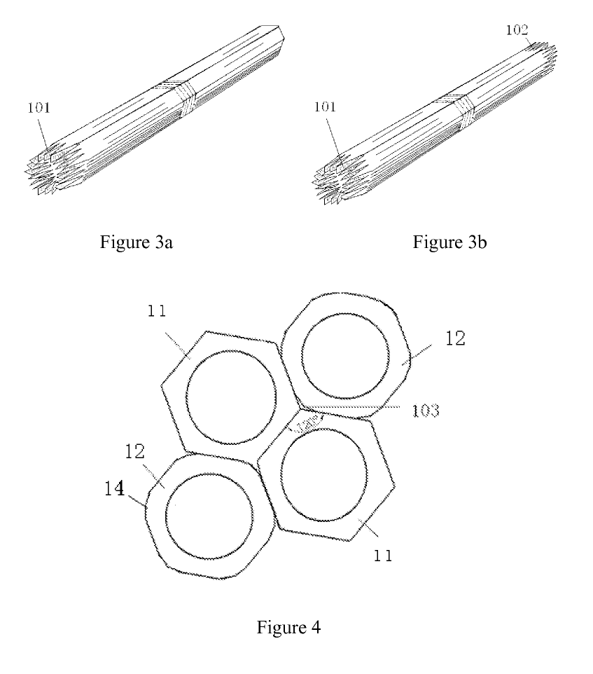

(5) One end 101 or both ends 101,102 of bamboo unit is milled to be finger joints (see FIG. 3a, 3b), which can allow the finger jointing blank has unlimited length.

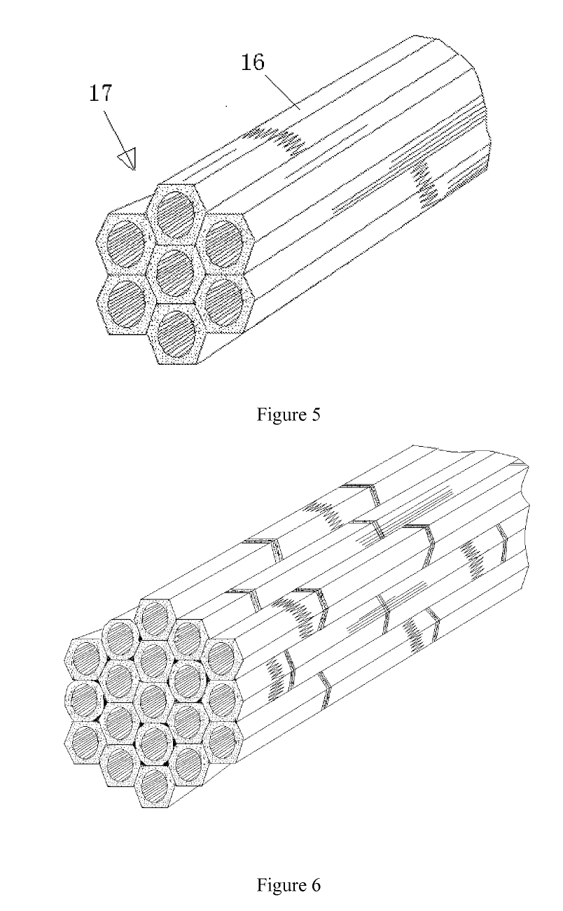

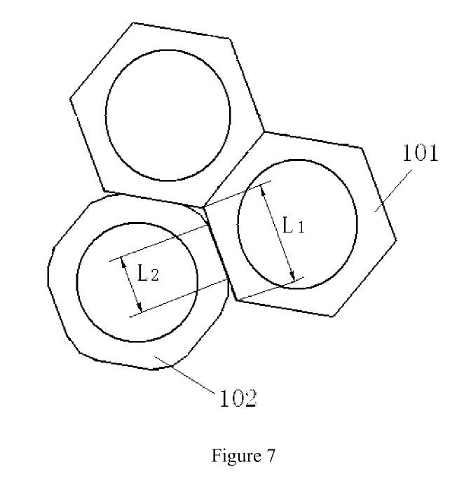

(6) Adhesive is coated on the connecting face of finger joints of hexagonal bamboo unit, which allows the substrate of prestressed structural material formed by hexagonal original bamboo elongate to any wanted length. For example, several bamboo units 10a that has different length can be longitudinally jointed to single blank. The total length of the blank in this embodiment can be 6000 mm(see FIG. 5)

(7) Assembling the bamboo units 10a coated with adhesive into blank, pressing the blank in vertical direction relative to the blank, curing the adhesive under atmosphere or heating temperature, then the single hexagonal blank with the length of 6000 mm is formed; said adhesive can be selected form conventional adhesive, such as PVAc (vinyl acetate resin), UF (urea formaldehyde resin), PF (phenolic resin), MDI (isocyanate glue) or other adhesive used in the field. Bonding methods and conditions are routine.

(8) Reorganizing the bamboo blanks according to the requirement, in order to realize wanted hexagonal original bamboo reorganization. In practice, coating on the adjacent side surface of plurality hexagonal blanks with adhesive, next arranging the blank abreast in form of honeycomb, then pressing the blank laterally, with or without heating to curing the adhesive, in order to form lateral reorganization (see FIG. 4,5); if the single bamboo blank with ends that are different from each other, as shown in FIG. 2b, during lateral reorganization, the bigger and smaller ends 11,12 can be placed alternatively (see FIG. 4). So that the gaps 103 formed by the original arc of plurality bamboo units can be as small as possible.

(9) Then sawing, sanding, painting, etc., said substrate of prestressed structural material formed by reorganization with hexagonal original bamboo, the reorganized material 30 can be formed by sawing according to its required size. Also, the second reorganization can be carried out according to requirement, that is, as shown in FIG. 5, plurality hexagonal bamboo substrates 17 are bonded on side surface of it to form reorganized substrate with bigger cross-section, or bonding more hexagonal blanks on the reorganized substrate 17 to form substrate 30 of prestressed structural material with bigger cross-section(or see FIG. 6).

(10) Opening up the knots of all or part of bamboo units 31 of substrate 30 in cross-section direction by machinery, manual or other ways (see FIG. 9). then the lacing wire 41 extends through the opened knots, lacing wire can be steel, nylon, rubber, plastics or other high-strength composite material that can generate high-strength prestress. Type, diameter, length of lacing wire can be determined according to the strength and size of required structural material. Since the lower layer of prestressed structural material is the most fragile part during bearing, so that the lacing wire should be disposed in bamboo unit in tensed layer of substrate 30 in cross-section direction.

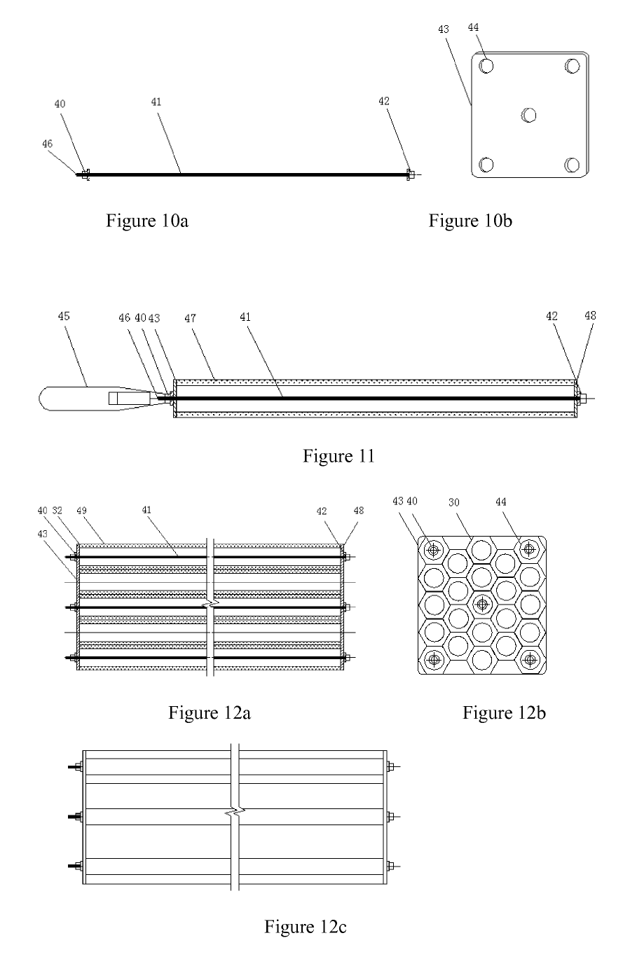

(11) Corresponding high-strength baffles 43 and 48 are disposed on both ends of substrate 30 of prestress structural material formed by reorganization with polygonal original bamboo; holes 44 for allowing lacing wire extend through are disposed on both baffles (see FIG. 10b). As shown in FIG. 11, ends 46 of lacing wire extend through the hole 44, which the extending is carried out inside single blank namely longitudinal bamboo 47, and means 45 for fastening lacing wire 41 on baffle 43 is used. Means 45 for fastening the lacing wire can be buckles disposed on both ends of lacing wire and its matching nuts 40 and 42, or the anchor normally used in architecture; the prestress can be generated by anchor or threading the nuts to tauten the lacing wire 41, in order to use it as reinforcement material, so that the mechanical strength of prestressed structural material improves further; ends of lacing wire protrudes from the outer of baffle can be cut, which is convenient for using. Step of bamboo green removing can be added between the confirming and boiling steps, that is remove the green layer from the bamboo segment.

Referring FIG. 1-6, the diameter difference clearance between two ends of segment of bamboo unit 10a for manufacturing the prestress structural material can be within ±15 mm, after milling on outer surface of bamboo, the bamboo unit become even hexagonal bamboo unit, finger joints can be milled at one or both ends. If the longitudinal finger jointing bamboo unit reach certain length (such as 6000 mm), lateral assembling bamboo unit can form the substrate of prestress structural material formed by reorganization with hexagonal bamboo units. With adhesive coated on all said bonding faces, and the pressing under atmosphere and/or elevated temperature, prestress structural material reorganized with hexagonal bamboo unit is formed with any length. Referring FIG. 9, 10a, 10b, 11,12a, 12b, 12c, lacing wire 41 extends through substrate of prestress structural material reorganized with hexagonal bamboo unit, and the buckles are disposed on both ends of lacing wire, combining with the nuts, both ends of lacing wire can be fastened on baffles, so the prestress lacing wire acts as reinforcement material, then the prestress structural material reorganized with hexagonal bamboo unit is formed.

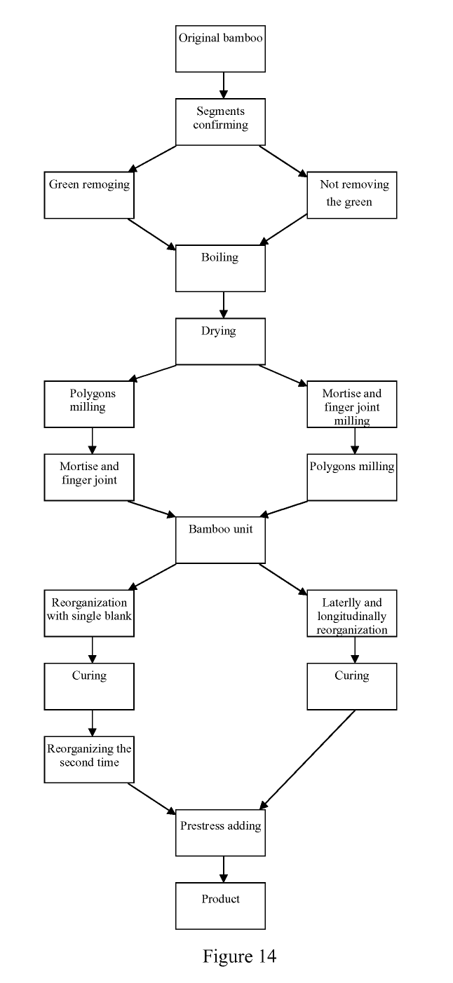

Thus, prestress structural material 49 reorganized with hexagonal bamboo unit is formed. Major processing steps are shown in FIG. 14.

In the embodiment, during reorganization, plurality bamboo units form single blank by finger joints at the first place, then lateral reorganization is carried out with those plurality bamboo blanks. During reorganization can be performed at the meantime, adhesive can be coated on plurality bonding side faces of hexagonal bamboo units and on the finger connecting face, hexagonal bamboo units is placed abreast in form of honeycomb; meanwhile, arranging the bamboo units longitudinally, seams of bamboo units can be arranged alternatively in longitudinal direction as soon as possible, the reorganized bamboo can be carried out according to different section size and length. Pressing the coated and reorganized bamboo at both vertical and lateral direction at the same time, then curing under elevated or atmosphere temperature, so the substrate is formed, after that, the lacing wires extends through the bamboo units, and baffles are disposed at both ends of lacing wires, tautened lacing wire act as reinforcement material in the form of fastening on baffles, finally the prestress structural material is formed. Properly speaking, size of the holes for lacing wire extending through affects the strength of prestress structural material. However, as long as the knots around the wall of bamboo can be kept as a little ring, the size of holes can't affect the strength of prestress structural material within limits, so it's better to keep the knots as much as possible. Thus, size of opened holes is better to be extended by lacing wire exactly.

### Example 2

In example 1, the step (4) and (5) can be reversed, that is in this example, the longitudinal finger joints milling and finger jointing can be step (4), and the milling of hexagonal bamboo can be step (5), while other steps is the same with first embodiment. The main processing steps shown in FIG. 14.

### Example 3

During assembling, longitudinally assembling of single blank can be prior to lateral reorganization; or longitudinal and lateral assembly can be carried out at the same time. That means step (7), (8), (9) is different from first embodiment, and the other steps are still the same with first embodiment. The main processing steps shown in FIG. 14.

### Example 4

Compared to first and second embodiment, substrate is formed by different bamboo unit in this embodiment.

First of all, bamboo with basically the same diameter includes 2 kind of bamboo units, one of which is the segment with bigger diameter, the other of which is the segment with smaller diameter, various bamboo units formed by each kind of segments confirms their segments according to the confirming principle of first embodiment.

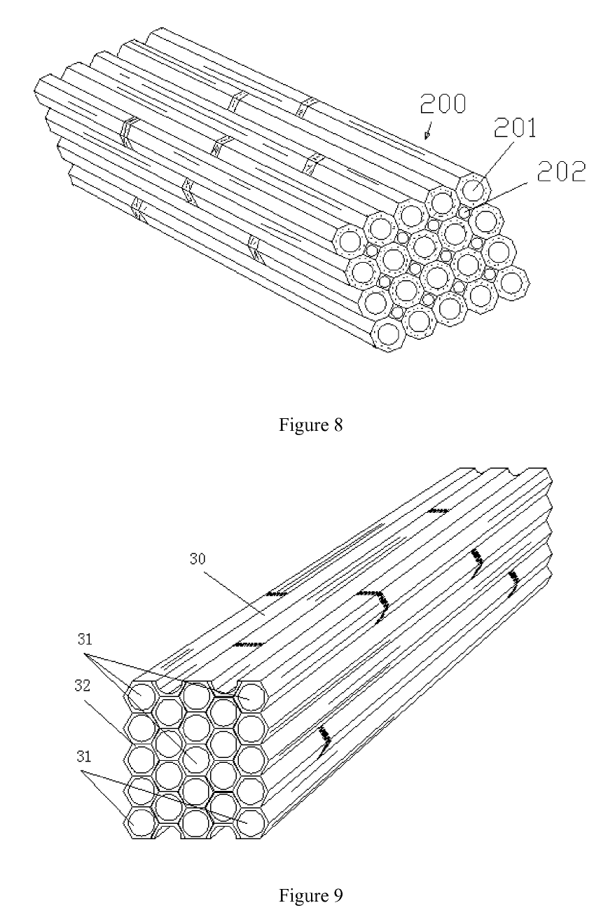

Then, bamboo segments with bigger diameter are milled into octagonal bamboo unit 201, and bamboo segments with smaller diameter are milled into foursquare bamboo unit 202, the side length of cross-section of foursquare bamboo unit 202 is correspondingly equal with the side length of cross-section of octagonal bamboo unit 201. Milling finger joints at one end or both ends of these two kind of bamboo units, then longitudinally reorganizing the bamboo units according to reorganizing method that described at step (4) in first embodiment and step (5) in second embodiment, laterally reorganizing the bamboo after that or at the same time according to the way shown in FIG. 8. Other steps are the same with first and second embodiment.

This reorganization improves the utilization rate of bamboo.

Relates to the bamboo with bigger diameter, the bamboo with smaller diameter (which is ≦40 mm) has the thicker wall, so it can be milled to be foursquare bamboo unit that act as “filling” material for the inner space of octagonal reorganized material. Besides, the wood can be used as “little square” for “filling” into the inner space, to form “reorganized composite material formed by polygonal original bamboo and wood”.

For the bamboo with smaller diameter, we can mill all the bamboo into foursquare bamboo unit then reorganize it.

During the reorganization of foursquare bamboo unit, bamboo unit used in assembling can be the same or different. When the side length of plurality foursquare bamboo unit is not the same, the side length is better to be multiple relation.

Again, reorganization described above can also use pentagonal or heptagonal bamboo units. During the reorganization of pentagonal bamboo unit, there are holes among various bamboo units in the cross-section direction after reorganizing the pentagonal bamboo units. According to using requirement, the holes can be filled with filling material like wood units and bamboo units, or the hole can be reserved. Or reinforcing bars can extend through these holes, or we can use the filling material filling the holes, and then extend the lacing wire inside the filling material. Or we can extend the lacing wire through the holes among bamboo units and the bamboo unit. So, the trouble caused by going through the knots can be avoided and the holes can be used effectively.

Side number of bamboo unit in the cross-section direction is not arbitrary. If the number is too little, for example the bamboo is milled into triangle in the cross-section direction, it is inadvisable, since the wall of bamboo can undergo penetrably breaking, then the performance of natural structure can be weakened; if the number is too much, for example it's 10 or more, it is also inadvisable, since the side length become too short to ensure enough bonding face for reorganization, then the bonding strength can be reduced.

Thus, preferred side number of bamboo unit is 4-8 according to present invention.

1. Prestress structural material formed by reorganization with polygonal original bamboo, characterized in that: the structural material is formed by a number of bamboo units, the cross-section of which is polygon, adhesive layer coated on outer surfaces of two adjacent laterally contacting bamboo units enables a number of bamboo units bonds together, which forms the laterally side-to-side ranging structure, so that the freely lateral expansion is achieved; finger joints are disposed longitudinally at connecting ends of said two bamboo units, adhesive layer coated on the connecting face of finger joint of bamboo units enables the bamboo units firmly connecting together by finger jointing, so that freely longitudinal elongation is achieved, then the prestress structural material formed by reorganization with polygonal original bamboo is formed; stress steel elements are disposed to go through at least part of bamboo units of prestress structural material formed by reorganization with polygonal original bamboo, and baffles are disposed at both ends of the structural material in order to fasten the stress steel elements, both ends of said stress steel elements are pulled and fastened on the baffles.

2. Prestress structural material formed by reorganization with polygonal original bamboo according to claim 1, characterized in that: knots of bamboo units which locate in underlying and/or corners and/or periphery and or center of the cross-section of the structural material are opened up, and the stress steel elements extend through the opened knots.

3. Prestress structural material formed by reorganization with polygonal original bamboo according to claim 1, characterized in that: said baffles are disposed with holes in the locations where the corresponding said stress steel elements protrudes; the ends of stress steel elements extend through said holes, and the ends are fastened on baffles.

4. Prestress structural material formed by reorganization with polygonal original bamboo according to claim 3, characterized in that: said stress steel elements are tautened by anchor in order to fix on baffle in form of generating the prestress; and/or either end of stress steel elements is flush with the outer face of anchor sor baffles; or both ends of said stress steel element are disposed with buckles, in order to engage with nuts rotatablely, which enables both ends of said stress steel element being tautened in the form of generating the prestress on said baffles; and/or either end of stress steel elements is flush with the outer face of anchors or baffles.

5. Prestress structural material formed by reorganization with polygonal original bamboo according to claim 3, characterized in that: said stress steel elements are prestressed lacing wire which is made by steel materials, nylon, rubber, plastic or composite materials; and/or, said baffles are made by steel material.

6. Prestress structural material formed by reorganization with polygonal original bamboo according to claim 1, characterized in that: edges number of profile of said polygonal bamboo units' cross-section is 4-8.

7. Prestress structural material formed by reorganization with polygonal original bamboo according to claim 6, characterized in that: edges number of profile of said polygonal bamboo units' cross-section is 6, each said bamboo units' cross-section is hexagon; and the units are abreast placed in form of honeycomb, the units bond together to freely expand via said adhesive layer; said hexagonal bamboo units can be elongated freely by said finger joints and adhesive layer; or
said bamboo units includes one units formed by plurality octagonal original bamboo and one units formed by plurality foursquare original bamboo, edge length of profile of the foursquare units' cross-section equals to or multiple to octagonal units', in order to place the foursquare units into the quadrangular gaps forms after the foursquare units being bonded; or
said bamboo units comprise two groups formed by plurality foursquare original bamboo, and each group has different edge length.

8. Prestress structural material formed by reorganization with polygonal original bamboo according to claim 1, characterized in that: longitudinally connecting ends of said bamboo units are milled to be finger joints, in order to achieve longitudinally mortise elongation; and/or, seam of jointing alternatively arrange.

9. Prestress structural material formed by reorganization with polygonal original bamboo according to claim 1, characterized in that: said plurality bamboo units are those bamboo units that have substantially same profile and same edge number; or
said plurality bamboo units comprise two or more bamboo units, profile of cross-section of the bamboo and the edge number of the bamboo in the same units is the same, while bamboo in the different units its profile of cross-section and/or the edge number is different, bamboo in the same units can be elongated by mortise structure, bamboo units in the same or the different units can be expanded by laterally bonding; or
said plurality bamboo units are those bamboo that have substantially the same profile and same edge numbers, as well as one units that bamboo have different profile, and the units is fit for the gaps that forms among the bamboo units, and fill in those gaps.

10. Prestress structural material formed by reorganization with polygonal original bamboo according to claim 1, characterized in that: ratio between side length of cross-section profile of polygonal bamboo units L2 and side length of inscribed polygon in the circle that has same diameter is called multi-degree, multi-degree of the L2/L1 ≧40%; and/or,
Said bamboo units are made by bamboo of which the diameter is basically equals, which the difference value between both ends could be one constant value, and the bamboo is cut to be segment in where there is no knots, said segment is milled to be polygonal on the outer surface, connecting ends for mortise connecting is milled to be finger joint, in order to form the units; and/or
various said segment is divided into at least on group, average diameter difference clearance of segment in same group could be within ±15 mm; difference value of diameter of both ends of segment could be within ±10 mm.

11. Prestress structural material formed by reorganization with polygonal original bamboo according to claim 5, characterized in that: said steel prestress lacing wire is made of steel bar or bundle of steel bars or bundle of steel strands.

12. Manufacturing method of Prestress structural material formed by reorganization with polygonal original bamboo, includes manufacturing substrate of prestress structural material formed by reorganization with polygonal original bamboo, and adding reinforcement material, manufacturing said substrate by laterally and longitudinally connecting plurality units formed by original bamboo to be reorganized materials which have set length and cross-section area; adding said reinforcement materials, which is adding a lacing wire that has the same length with said substrate in form of longitudinally going through inside and/or between at least part of units of substrate, then fastening both ends of lacing wire respectively to both ends of substrate.

13. Manufacturing method according to claim 12, characterized in that: said substrate of prestress structural material formed by reorganization with polygonal original bamboo is formed by bamboo units with polygon profile or polygonal bamboo units, manufacturing method of substrate is: manufacturing plurality flat planes on original bamboo outer surface in order to form bamboo units that its cross-section is polygon, adhesive layer coated on outer surfaces of two adjacent laterally contacting bamboo units enables plurality bamboo units bonds together, forming laterally side-to-side ranging structure, so that the freely lateral expansion is achieved; finger joints are disposed on longitudinally connecting ends of said two bamboo units, adhesive layer coated on connecting face of the finger joint of bamboo units enables the bamboo units firmly connecting together by finger jointing, so that freely longitudinal elongation is achieved, then the prestress structural material formed by reorganization with polygonal original bamboo is formed.

14. Manufacturing method according to claim 12, characterized in that: manufacturing steps of processing bamboo units of substrate of prestress structural material formed by reorganization with polygonal original bamboo includes:
A. confirming the length of bamboo segments: that is cutting bamboo segment with set length from original bamboo;
B. boiling: steaming or boiling bamboo segment;
C. drying: drying the boiled bamboo segment till the moisture content reaches 5%˜20%;
D. milling and cutting: milling the dried bamboo segment on its side surface in order to make it polygon and milling finger joints at the longitudinally connecting end of bamboo segment;
assembling the bamboo segments that processed according to above described steps: adhesive is coated on the side milling face and finger joints at the ends of bamboo units, in order to laterally and longitudinally bonded the units, then pressing the plurality units to be said substrate under atmosphere or elevated temperature; or the processing also comprise:
between said confirming step and boiling step, one step for removing the bamboo green can be added, which is removing the green layer on the outer surface of bamboo segment.

15. Manufacturing method according to claim 12, characterized in that: said reinforcement materials also includes baffles, during the adding step of said reinforcement materials, the lacing wire extends through the bamboo units of substrate of prestress structural material formed by reorganization with polygonal original bamboo, baffles for tightening the lacing wire are disposing on both ends of said substrate, and anchors or nuts is used for fastening both ends of lacing wire on the baffle.

16. Manufacturing method according to claim 12, characterized in that: all or part of knots of bamboo units forming the substrate are thrilled, then lacing wire are going through the hollow bamboo;
or, cross-section of holes for lacing wire to go through said bamboo units is basically corresponding to cross-section of lacing wire, which ensures the thrilling holes of lacing wire to be the size that keeps the knots as much as possible, that is ensuring the thrilling hole as small as possible while ensuring the thrilling of lacing wire; and/or,
when there are holes between said bamboo units, all or part of lacing wire thrilling through the holes.

17. Manufacturing method according to claim 12, characterized in that: during the adding of lacing wire, said lacing wire are fastened by anchors on baffle, tightly pulling the lacing wire when fastening in order to generating the prestress; and/or cutting the ends of lacing wire protruding from outer side of baffles; or,
disposing buckles on both ends of lacing wire, then both ends of lacing wire are fastening on baffle by suitable nuts, tightly pulling the lacing wire when fastening in order to generating the prestress; and/or cutting the ends of lacing wire protruding from outer side of baffles; or,
the seams of longitudinally mortise jointing are alternatively arranged on the lateral direction of said substrate; or,
said bamboo units is cut to be segment by sawing in where there is no knots; outer side of said segment is milled to polygon, finger joint is cutting at the connecting ends for mortise connecting, then assembling units is formed.

18. Manufacturing method according to claim 14, characterized in that: during B step of boiling, the bamboo segment were placed in boiling alum solution; or putting alum into water, then heating the solution, finally the saturated alum solution in boiling water is generated, bamboo segment are put into hot water and boiled under the temperature of 100° C.˜200° C., and the pressure of 0.1 Mpa˜1.6 Mpa for about 4-6 hours, then the bamboo segment undergo the drying step;
and/or,
during C step of drying, bamboo segment are placed into drying kiln in order to dry under hypothermia condition, the temperature is 30° C.˜50° C.;
and/or,
during D step of milling, step of said mill finger joint and polygon can be reversible;
and/or,
during step of assembling, order of said longitudinally and laterally assembling can be reversible.

19. Prestress structural material formed by reorganization with polygonal original bamboo according to claim 2, characterized in that: longitudinally connecting ends of said bamboo units are milled to be finger joints, in order to achieve longitudinally mortise elongatation; and/or, seam of jointing alternatively arrange.

20. Prestress structural material formed by reorganization with polygonal original bamboo according to claim 6, characterized in that: said plurality bamboo units are those bamboo units that have substantially same profile and same edge number; or
said plurality bamboo units comprise two or more bamboo units, profile of cross-section of the bamboo and the edge number of the bamboo in the same units is the same, while bamboo in the different units its profile of cross-section and/or the edge number is different, bamboo in the same units can be elongated by mortise structure, bamboo units in the same or the different units can be expanded by laterally bonding; or
said plurality bamboo units are those bamboo that have substantially the same profile and same edge numbers, as well as one units that bamboo have different profile, and the units is fit for the gaps that forms among the bamboo units, and fill in those gaps.
